(19) United States
(12) Patent Application Publication
(10) Pub. No.: US 2008/0060577 A1
(43) Pub. Date: Mar. 13, 2008

(54) Paint Shield With Levels

(76) Inventors: Ray Call, Mission Viejo, CA (US); Olivier Hennessy, Aliso Viejo, CA (US); Scott Struthers, San Clemente, CA (US); Craig Childs, Elk Grove, CA (US)

Correspondence Address: Rutan & Tucker, LLP., 611 ANTON BLVD, SUITE 1400, COSTA MESA, CA, 92626, US

(21) Appl. No.: 11/555,338

(22) Filed: Nov. 1, 2006

Related U.S. Application Data
(60) Provisional application No. 60/824,864, filed on Sep. 7, 2006.

(51) Int. Cl. B05C 11/11

(52) U.S. Cl. 118/504

(57) ABSTRACT

A paint shield for a mounting bracket comprising a member having a front side, a back side, and at least one edge and at least one level disposed on the member. There can be a horizontal and a vertical level disposed on the paint shield. The paint shield with built-in levels are attached to a mounting bracket for installing a speaker unit on a wall or panel and can be reused after being removed

### FIELD OF THE INVENTION

The field of the invention is in paint shield for a speaker mounting system.

### BACKGROUND

Conventional methods for installing speakers in a wall or ceiling is to first use a stud finder to locate an area suitable between two studs suitable for an opening. Then an installer will have to trace a pattern of the speaker onto the wall for the opening. Most of the time, the installer has to use a carpenter's level to ensure that the pattern traced is centered and leveled. Once the hole is cut, a mounting bracket is installed, then some portions of the speakers may be installed depending on the type of the speakers. A paint shield is installed so the usually unfinished walls can be spackled and painted before the speaker units can be installed. Otherwise, paint and spackle can damage the inner speaker or the mounting bracket of the speaker, which may be displayed along with the speaker. After painting and spackling, the paint shield can be removed and the mounting bracket are protected.

One of the difficulties in installing speakers on a wall is to level the speaker mounting system with the wall. Most speaker instructions require the installer to use a carpenter's levels to locating the desired leveled position for speaker installation. See http://www.bose.com/pdf/customer service/owners/og 191.pdf. Some speaker units do not provide patterns for tracing and users have to generate one themselves or hold up one of the mounting bracket along with a carpenter's level to center the hole. Not only can this method be cumbersome since an installer has to hold the bracket, the carpenter's level and a marker, but it can cause unevenness if not careful. If not properly centered, re-drilling the wall runs the risk of further causing more permanent damages to the wall.

To solve the problem, there are speakers with built-in levels on the front grille of the speakers themselves. They are, however, inconveniences for many reasons. First, since most installation of in-wall speakers require cutting an opening prior to the installation of the actual speakers, the built-in level on the speakers themselves are not practical. By the time the speakers are installed, it is already too late to assess whether the opening is centered. Second, being permanently attached, the built-in level on the speaker is not aesthetically pleasing. Finally, once the speaker is installed, the levels serves no further purpose and cannot be reused gain.

Thus, there still is a need for to level a mounting bracket that accommodates a speaker unit on a wall.

This and all other referenced patents and applications are incorporated herein by reference in their entirety. Where a definition or use of a term in a reference, which is incorporated by reference herein is inconsistent or contrary to the definition of that term provided herein, the definition of that term provided herein applies and the definition of that term in the reference does not apply.

### SUMMARY OF THE INVENTION

The present invention provides apparatus, systems and methods in which a paint shield for a mounting bracket comprises a member having a front side, a back side, and at least one edge and at least one level disposed on the member. The paint shield has a horizontal level and/or a vertical level that are disposed discretely on the member.

In preferred embodiments, the level is a bubble level with liquid inside and disposed on the front side of the member for better reading. However, the level can be other types of levels and can be disposed through the front side to the back side of the member. In alternative embodiments, the paint shield can be a rectangular or an ovoid shape that includes any square or circular shapes.

It is contemplated that the paint shield can be any shape and sizes to accommodate any type of mounting bracket. The material of the paint shield can be a plastic or other durable conventional material.

In yet another preferred embodiments, the paint shield has at least one attachment position and more preferably four attachment positions. The paint shield then can be screwed on to a mounting bracket or the edge of the member can slide onto a groove along a side of the mounting bracket. Other types of attachment mechanism is contemplated also, such as a snap on mechanism.

It is contemplated that an installer can reuse the paint shield for different mounting brackets. For multiple speaker installation, the paint shield can be used on all of them for convenience.

In preferred embodiments, a speaker installation kit comprises a member having a front side, a back side, and at least one edge; at least one level disposed on the member; attachment positions disposed on the member; and a speaker.

In other preferred embodiments, a method of installing a speaker using a paint shield comprising: attaching the paint shield with a built-in level to a mounting bracket; leveling the mounting bracket using the levels within the paint shield to locate a desired position point; attaching the mounting bracket to the desired position point and further comprising unattaching the paint shield.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

FIG. 1 is a front perspective drawing of the present inventive subject matter.

FIG. 2 is a side perspective drawing of different types of speakers.

FIG. 3 is a perspective drawing of a circular paint shield.

FIG. 4 is a perspective drawing of a square paint shield.

### DETAILED DESCRIPTION

The present invention provides a paint shield with built-in levels. The paint shield is a piece of plastic that covers the speaker griller during installation. After installing the grille into the wall and before the speaker is installed, the paint shield is removed. It can be reused again. The built-in levels can be located anywhere on the paint shield to provide leveling for the installer.

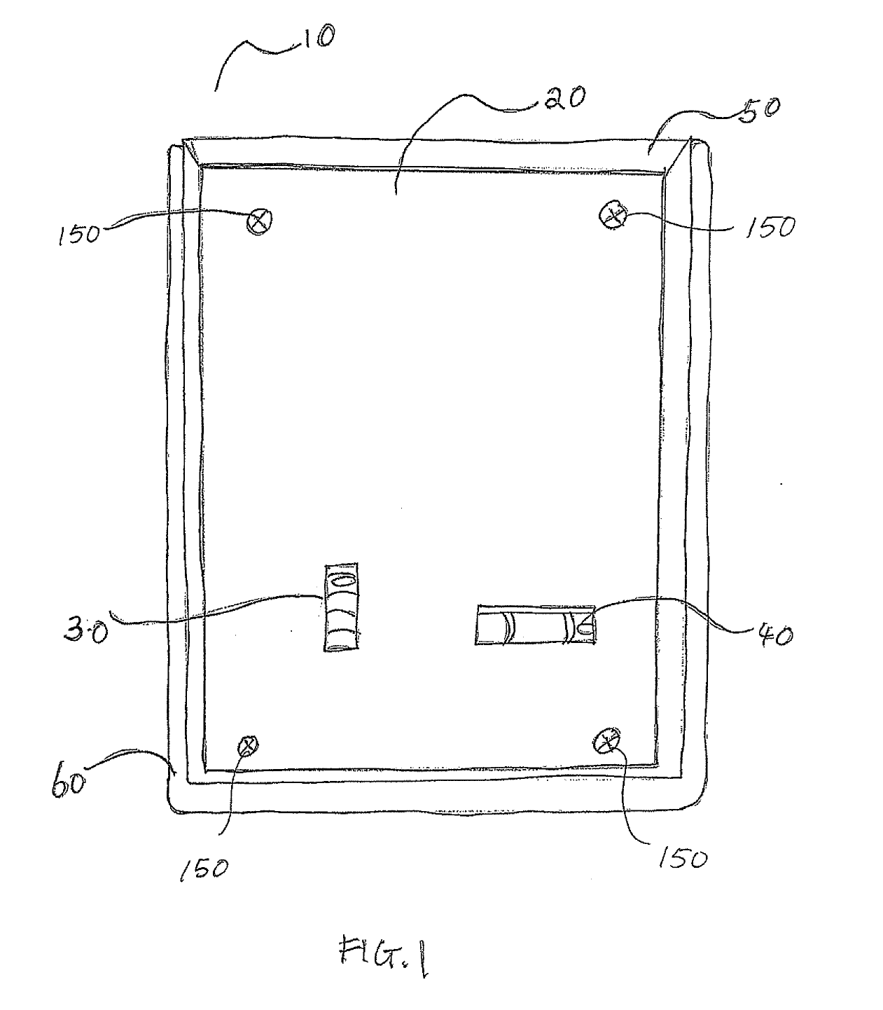

As shown in FIGS. 1, a paint shield 10 comprises a member 20 that accommodates a vertical level 30 and a horizontal level 40 disposed on a mounting bracket 50.

Member 20 can be a flat surface that has front side 100 and back side 102. Front side 100 and back side 102 can be as thick as 2 cm, but preferably, it is less than 1.5 cm. Preferably, member 20 is a rectangular shape and has four edges 104, 106, 108, and 110 extending towards to the back side and away from the front side. It is contemplated that member 20 is made of polyurethane plastic or any other type of durable material that compliments a mounting bracket system.

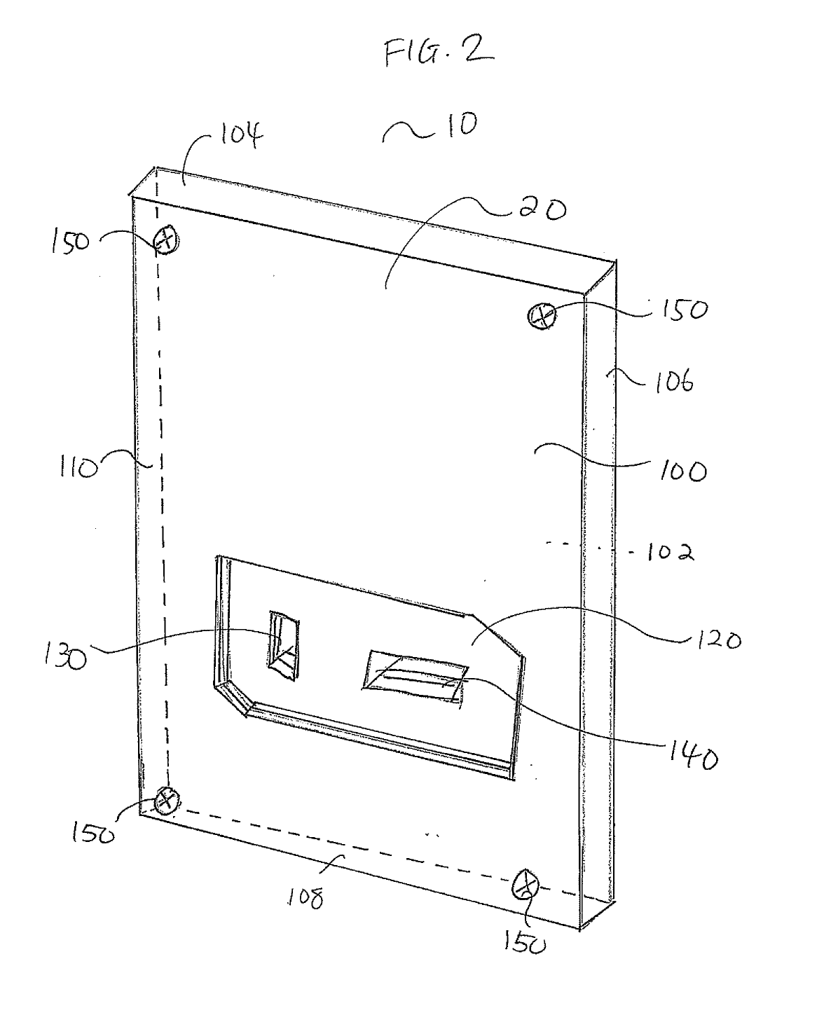

Vertical level 30 and horizontal level 40 are built in on an area of member 20. The levels preferably are in an area that is not around the perimeter of the member as to avoid being painted over. A special area 120 can be carved out on the member to emphasis the area where the levels are located as shown in FIG. 2. Preferably, a horizontal and vertical levels are placed closed to each other, approximately 2.5 cm apart for ease of reading. It is also contemplated that multiple number of levels can be used on the paint shield. Preferably, a horizontal and a vertical level are used. However, a single level can also be an option.

In preferred embodiments, the levels are of conventional level vials. Preferably, acrylic plastic ones are used. It is contemplated, however, that different other durable levels vials are used. The level vials are bubble level vials that can come in many shapes and sizes. Preferably, the levels with length range from 10 mm to 45 mm and a diameter of 5 mm to 12 mm. The levels, preferably, have tight tolerance cylindrical bodies have barrel-shaped interiors. The barrel-shaped or bubbled shaped vials have long lasting, hot-stamped markings and fluorescent color, such as green or yellow, fluid for high visibility.

Other types such as the circular and curved vials are also contemplated. Preferably, the levels have flanges and the level vials can be snapped into the flange with a “push-fit” into the paint shield to save space and to provide a non-protruding surface. However, it is possible to attach the level vial on top of a surface of the paint shield if desired. Flanges are made of extruded plastic or other type of suitable materials.

The most important requirement of a level is the sensitivity of the vial itself. Federal specifications call for a 45 minute minimum vial sensitivity. The lower the number falls below 45 minutes the more sensitive it is. Other types of levels, such as laser levels, are also contemplated.

The levels are preferably built in or embedded in the paint shield as shown in FIG. 1. Levels can be welded or attached via other conventional methods. It is also contemplated that levels are embedded in special area 120 on member 20 as shown in FIG. 2. Special area 20 is portion of the front side of the member that has been cut to accommodate the levels. Special area 120 can be any shape or sizes, preferably large enough or 5 cm by 5 cm to accommodate at least two level vials. Then within the special area 120, vertical level area 130 and horizontal level area 140 are carved out to accommodate the levels. Level vials then can be embedded in the level areas.

By being embedded in the paint shield, this minimized damages that can be caused during operation or transport of the paint shield unit. It is also contemplated that the levels can be removed from the paint shield and installed when they are needed. Furthermore, while it is preferred to have the levels on just the front side of the paint shield, they can also be visible on both the back and front side. The levels are contemplated to be situated in a cut-out area (not shown) on member 20 to give more flexibility for using the levels.

It is contemplated that the paint shield can be round, square, or any other shape that accommodates a mounting bracket.

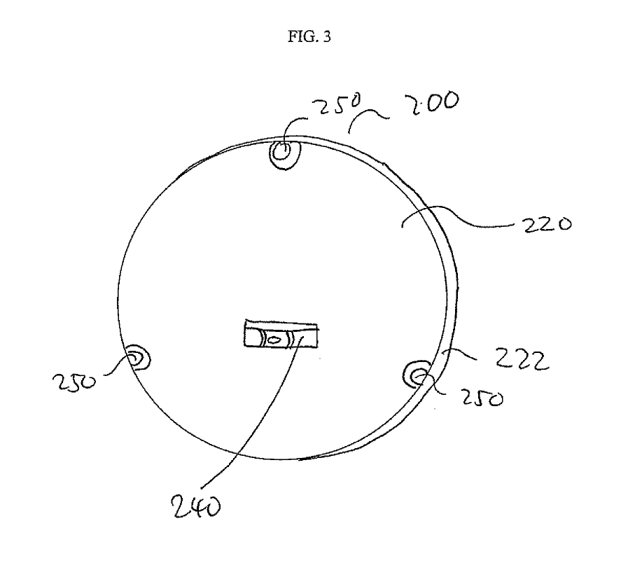

FIG. 3 demonstrates a circular paint shield 200 with built in levels. Member 220 has one edge 222 and there are three screws 250 instead of four. Preferably, level 240 is located in the center of member 220, but it is not limited to just the center. Level 240 can be located anywhere on member 220 as long as it can be visibly seen during installation and not obstruct any other parts. Preferably the diameter of member 220 is at least 10 cm. However, depending on the size of the speaker units, the diameter can be smaller or larger.

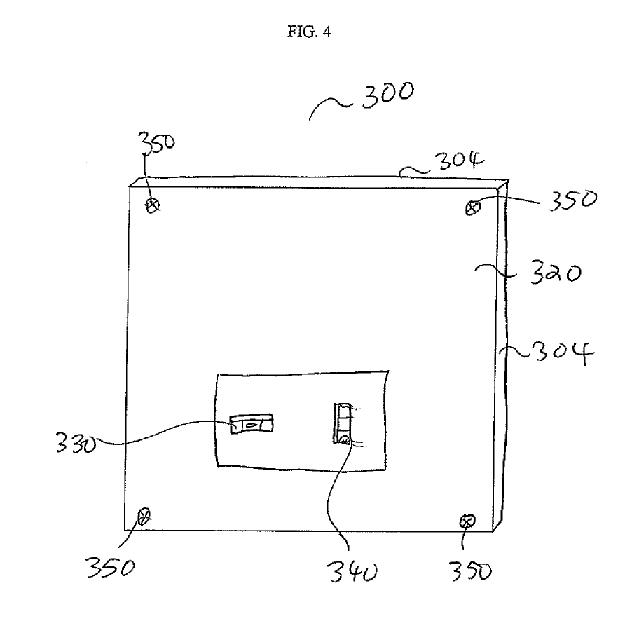

Similar to the rectangular paint shield, FIG. 4 demonstrates a square paint shield 300 that comprises a member 320 with four edges 304 all in equal length and preferably 10 cm in length. Again, the length of the edges are adjusted according to the speaker unit. Levels 330 and 340 are built in on an area of the member for installation. Four screws 350 are preferably located on each corner of member 320 for installation.

Preferably the paint shield if made of a plastic material or any light weight materials protects the speaker grille. The dimension of the paint shield depends on the size of the speaker. It can be made into any length or width to accommodate different speaker sizes and shapes.

The paint shield with the built in levels are placed over the speaker bracket during installation. Preferably, the paint shield is screwed onto the bracket via screws 150. Preferably each paint shield has four screws at each corner of the shield for attachment as shown in FIGS. 1-4.

It is contemplated that other modes of attachment are possible, such as a snap-on mechanism or using a level. Alternatively, four edges 104, 106, 108, and 110 can slide onto a receiving slot on the speaker mounting bracket.

During installation, the bracket and the paint shield are attached and work as one unit. Since the paint shield is disposed on the bracket, it will not hinder the bracket installation. Users will attach the paint shield via screws or other attachment methods. Once attached to the bracket, user can then install the speaker mounting bracket onto a drywall or any other existing wall or ceiling.

To cut an opening in the wall, installer simply uses the paint shield with the built in levels to find a center in the wall. No other external levels are needed. The paint shield can be used alone to center. More preferably, the paint shield with the built in levels are attached to the mounting bracket as one unit and is used as one unit for leveling.

With a vertical and a horizontal level, user can assess more accurately whether the bracket is leveled both vertically and horizontally. After finding the leveled position, the mounting bracket with or without the paint shield is installed. Depending on the types of speakers, it may be that the some portion of the speaker unit, such as a terminal plate has to be installed first before painting and spackling. Thus, the paint shield can be attached back to the mounting plate after the terminal plate has been installed. Optionally, the paint shield can stay attached to the mounting bracket and be installed as one unit and be removed after spackling and painting. The built-in levels are still in tact and the whole paint shield can be reused for another mounting bracket. The paint shield not only prevent damages or paint from getting into the bracket, it also serves as a device to level the bracket.

Those skilled in the art will appreciate that the paint shield and the bracket are installed in different ways. The paint shield and the bracket could, for example, be joined together at a job site. More preferably, however, the paint shield and the bracket are provided as an item of manufacture to the installer. Thus, in various embodiments a kit could contain one or more of a paint shield, a mounting bracket, a speaker housing, a speaker grille, installation screws, and instructions for installation. The installer would then provide whatever labor is appropriate for the installation, including installing the paint shield onto the bracket, optionally mounting the speaker housing to the wall panel.

While the preferred embodiment of the paint shield is for a speaker unit installation, those skilled in the art will appreciate that the paint shield with the built-in levels can be used in other applications, such as installation of art work, electrical units or other items that require centering and leveling on a wall.

Thus, specific embodiments and applications of paint shield with levels apparatus and methods have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A paint shield for a mounting bracket comprising
a member having a front side, a back side, and at least one edge and
at least one level disposed on the member.

2. The paint shield of claim 1, wherein the level is a horizontal level.

3. The paint shield of claim 1, wherein the level is a vertical level.

4. The paint shield of claim 1, wherein a plurality of levels are disposed discretely on the member.

5. The paint shield of claim 4, wherein at least one level is a horizontal level and one level is a vertical level.

6. The paint shield of claim 1, wherein the level comprises a bubble level.

7. The paint shield of claim 1, wherein the level comprises a liquid.

9. The paint shield of claim 1, wherein the level is disposed on the front side of the member.

10. The paint shield of claim 1, wherein the level is disposed through the front side to the back side of the member.

11. The paint shield of claim 1, wherein the member is substantially rectangular.

12. The paint shield of claim 1, wherein the member is substantially ovoid.

13. The paint shield of claim 1, wherein the member comprises a plastic.

14. The paint shield of claim 1, wherein the member comprises at least one attachment position.

15. The paint shield of claim 14, wherein the attachment position accommodates a screw.

16. The paint shield of claim 1, wherein the edge slides onto a groove along a side of the mounting bracket.

17. The paint shield of claim 1, wherein the member is reusable.

18. A speaker installation kit comprising:
a member having a front side, a back side, and at least one edge;
at least one level disposed on the member; and
at least one attachment position disposed on the member.

19. The speaker of claim 18 further comprising a speaker.

20. A method of installing a speaker using a paint shield comprising:
attaching the paint shield of claim 1 to a mounting bracket;
leveling the mounting bracket using the levels within the paint shield to locate at least one leveled position point; and
attaching the mounting bracket using the leveled position point.
